(19) United States
(12) Patent Application Publication
(10) Pub. No.: US 2013/0124937 A1
(43) Pub. Date: May 16, 2013

(54) METHOD AND APPARATUS FOR TRANSMITTING DATA IN DEVICE-TO-DEVICE SERVICE SYSTEM

(71) Applicant: Samsung Electronics Co. Ltd., Suwon-si (KR)

(72) Inventors: Kyung-Kyu KIM, Suwon-si (KR); Dae-Gyun KIM, Seongnam-si (KR); Seung-Hoon PARK, Seoul (KR); Chi-Woo LIM, Suwon-si (KR)

(73) Assignee: Samsung Electronics Co. Ltd., Suwon-si (KR)

(21) Appl. No.: 13/677,680

(22) Filed: Nov. 15, 2012

(30) Foreign Application Priority Data
Nov. 15, 2011 (KR) 10-2011-0119179

(51) Int. Cl. H04L 1/08

(52) U.S. Cl. CPC H04L 1/08
USPC 714/748

(57) ABSTRACT

A method for transmitting data in a second device that performs a Device-to-Device (D2D) service is provided. The method includes determining cooperative communication, if a value indicating a channel condition between a first device and a third device is less than or equal to a predetermined threshold, overhearing data transmitted from the first device to the third device and overhearing a response signal transmitted from the third device to the first device, to identify a transmission-failed data block of the first device, and if there are data transmission resources left at a predetermined scheduled data transmission time, transmitting the transmission-failed data block of the first device to the third device by piggybacking the transmission-failed data block on transmission data of the second device.

### PRIORITY

This application claims the benefit under 35 U.S.C. §119(a) of a Korean patent application filed on Nov. 15, 2011 in the Korean Intellectual Property Office and assigned Serial No. 10-2011-0119179, the entire disclosure of which is hereby incorporated by reference.

### BACKGROUND OF THE INVENTION

1. Field of the Invention

The present invention relates to a Device-to-Device (D2D) service. More particularly, the present invention relates to a method and apparatus for transmitting data in a D2D service system.

2. Description of the Related Art

In line with the development of communication devices and communication systems, users of the communication devices require services with which they can easily obtain or share their desired information anytime. Recently, the advent of smart phones and tablet Personal Computers (PCs) has provided an environment in which a variety of information may be obtained and shared over wireless communication systems. However, in the case of the wireless communication systems, users may not be able to obtain and share their desired information unless a suitable communication infrastructure is built. In addition, due to their system complexity and time delay, the wireless communication systems may have difficulty in efficiently providing the real-time information which is minor but useful in everyday life.

Accordingly, the Device-to-Device (D2D) service has been introduced, which may be performed directly between devices through a D2D link without the help of network entities such as base stations, and so may be used in areas where a communication infrastructure is has not yet been built.

A device supporting the D2D service acquires synchronization with its peripheral devices, discovers the peripheral devices using predetermined time and resources, and obtains device information of the discovered peripheral devices. The device information may include device's identification information, interest information, application information, and the like.

As described above, the D2D service performs a process of transmitting and receiving data through a communication link between discovered devices. Accordingly, there is a need to efficiently transmit data depending on the channel condition between devices in the data transmission/reception process.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for transmitting data in a Device-to-Device (D2D) service system.

In accordance with an aspect of the present invention, a method for transmitting data in a second device that performs a D2D service is provided. The method includes determining cooperative communication, if a value indicating a channel condition between a first device and a third device is less than or equal to a predetermined threshold, overhearing data transmitted from the first device to the third device and overhearing a response signal transmitted from the third device to the first device, to identify a transmission-failed data block of the first device, and if there are data transmission resources left at a predetermined scheduled data transmission time, transmitting the transmission-failed data block of the first device to the third device by piggybacking the transmission-failed data block on transmission data of the second device.

In accordance with another aspect of the present invention, an apparatus for transmitting data in a second device that performs a D2D service is provided. The apparatus includes a controller for, if a value indicating a channel condition between a first device and a third device is less than or equal to a predetermined threshold, determining cooperative communication, for overhearing data transmitted from the first device to the third device and overhearing a response signal transmitted from the third device to the first device via a receiver to identify a transmission-failed data block of the first device, and if there are data transmission resources left at a predetermined scheduled data transmission time, for generating data to transmit by piggybacking the transmission-failed data block of the first device on transmission data of the second device, a transmitter for transmitting the generated data, and a memory for storing the transmission-failed data block of the first device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 shows a communication process for a Device-to-Device (D2D) service according to an exemplary embodiment of the present invention;

FIG. 2 shows a communication flow for cooperative communication between devices in a D2D service according to an exemplary embodiment of the present invention;

FIG. 3 shows a process of transmitting data in a source device according to an exemplary embodiment of the present invention;

FIGS. 4A and 4B show a process of transmitting data in a helper device according to an exemplary embodiment of the present invention;

FIG. 5 shows a process of transmitting data in a destination device according to an exemplary embodiment of the present invention; and

FIG. 6 shows an apparatus for transmitting data in a device according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to the present invention, when performing cooperative communication in the D2D service, a helper device overhears data transmitted from a source device to a destination device and overhears a response signal transmitted from the destination device to the source device to identify or detect a transmission-failed data block of the source device, and then transmits the transmission-failed data block of the source device to the destination device by piggybacking the transmission-failed data block on transmission data of the helper device itself.

A method and apparatus for transmitting data in a D2D service according to an exemplary embodiment of the present invention will be described in detail below.

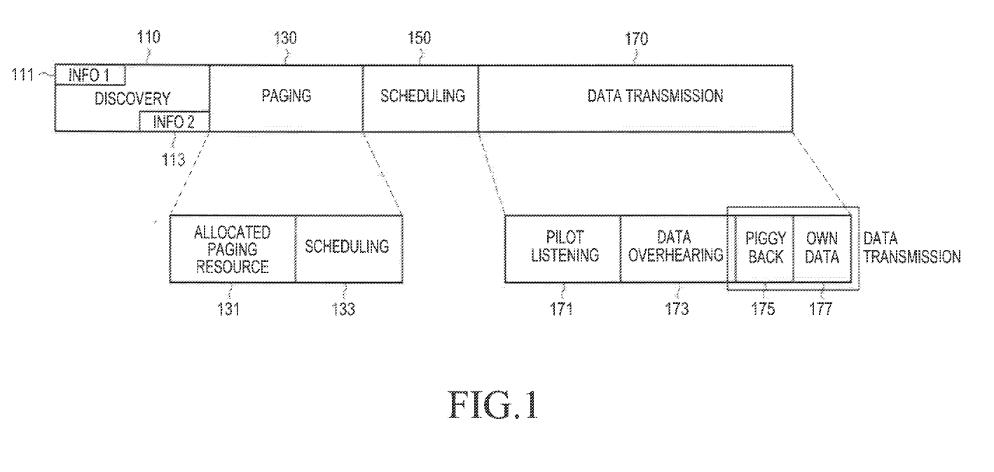

FIG. 1 shows a communication process for a D2D service according to an exemplary embodiment of the present invention.

Referring to FIG. 1, each of devices performs a discovery process 110 to find other devices (e.g., its peripheral devices). In the following description, for device discovery, each device of the system supporting the D2D service divides its device information into first information 111 to be transmitted based on a tone and second information 113 to be transmitted based on a sequence, and transmits the device information within a set discovery period. The device information may include device identification information, interest information, application information, and the like.

If there is data to transmit to a discovered device, each of the devices sends a paging request message to the device through a paging process 130, and selects a Connection ID (CID) by which a channel for transmitting data can be identified. The detailed paging process 130 is as follows. In order to be allocated resources for paging, a device is allocated resources 131 using a function that is mapped to resources based on the device's CID. A method of mapping resources to the CID is different depending on the mapping algorithm. Generally, the mapping algorithm varies depending on the uniqueness of resource allocation. If the resource allocation has uniqueness, the device identifies the resources mapped to its identification information to determine whether other devices attempt paging, and sends information about the allocated resources to the devices that will perform paging. The information may include a transmitting device's ID, application type, CID to be used, etc. The CID is broadcasted before transmission of the information, making it possible to identify the CID received within the network. However, since the resource mapping method in which the resource allocation has uniqueness causes a lot of resource consumption, efficient use of resources may be achieved by overlapped resource allocation that does not have uniqueness. In the resource allocation that does not have uniqueness, a resource mapping method that uses a code or is based on hopping may be used in order to prevent conflict of information transmission.

Upon receiving one or more paging request messages in the allocated resources, a device broadcasts a group Acknowledge (ACK) signal including a CID along with a paging response message 133 to determine the device's intent of communication with other devices that have paged the device itself. The paging response message is decoded by all devices that have attempted paging, so the devices having the same destination device may acquire each other's CID.

In a scheduling process 150, for data communication between the devices having the same destination device, timing is determined in which data is to be exchanged between the devices using the CID.

In a data transmission process 170, scheduling information is obtained using the CID, and since all devices know the CID, each of the devices may determine a channel condition between other devices and a condition of a channel passing through the device itself, using pilot messages of other devices 171. If a value indicating the channel condition between other devices is less than or equal to a predetermined threshold (i.e., if the channel condition between other devices is worse than the condition of a channel passing through the device itself), each of the devices overhears data 173 transmitted or exchanged between the other devices. If there are data transmission resources left at the device's data transmission timing, each of the devices transmits a transmission-failed data block in the overheard data to the destination device by piggybacking the transmission-failed data block 175 on the device's own data 177.

The communication process described with reference to FIG. 1 is performed when all devices in the network are synchronized with each other, and this process operates till a predetermined time depending on each sub process.

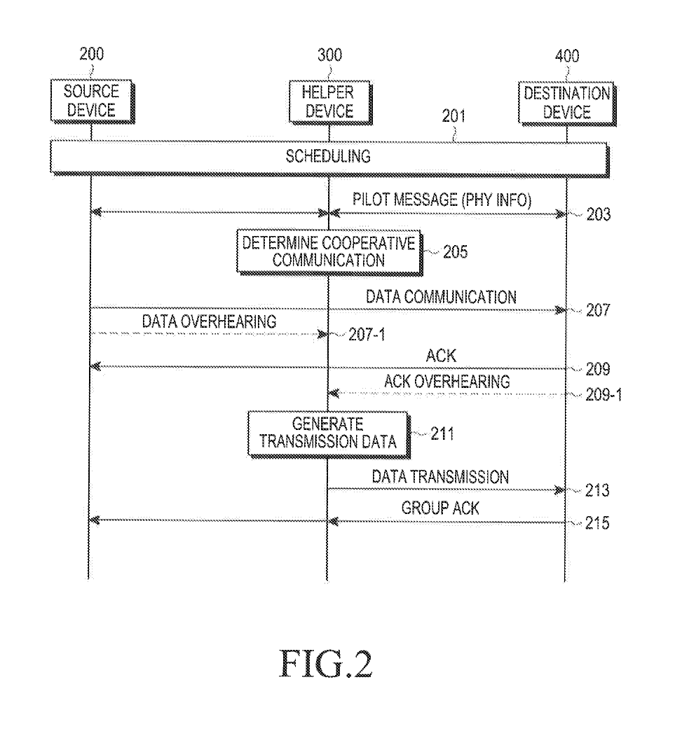

The data transmission process 170 corresponding to an exemplary embodiment of the present invention is described below with reference to FIG. 2.

FIG. 2 shows a communication flow for cooperative communication between devices in a D2D service according to an exemplary embodiment of the present invention. The process described in FIG. 2 occurs after the discovery process 110 and the paging process 130 has completed, in which each device determines the presence of peripheral devices, and determines the devices' intent.

Referring to FIG. 2, after acquiring a CID for communication with a destination device 400 in the paging process 130, a source device 200 determines its transmission order or timing by distributed scheduling in step 201. Since all devices that may cause interference to the source device 200 participate the scheduling, a helper device 300 also may determine its transmission order using the CID with the destination device 400. Through the paging process 130 and the scheduling process 150 and 201, the helper device 300 may acquire transmission orders of the source device 200 and the destination device 400. The scheduling process 150 and 201 may be applied in various different ways, and details thereof will not be mentioned herein. Using the technique for controlling interference occurring in the scheduling process 201, the source device 200, the helper device 300 and the destination device 400 may determine their own channel condition.

In step 203, the source device 200, the helper device 300 and the destination device 400 transmit physical information including channel quality, Modulation and Coding Scheme (MCS) level and data rate, to their peripheral devices by exchanging pilot messages before actual data transmission.

In step 205, the helper device 300 decodes the pilot message, determines a value indicating a channel condition between the helper device 300 and the destination device 400, and determines cooperative communication if its transmission efficiency is higher than or equal to a predetermined threshold. The helper device 300 determines cooperative communication if a channel condition between the helper device 300 and the destination device 400 is better than a channel condition between the source device 200 and the destination device 400.

In step 207, the source device 200 transmits data to the destination device 400. In step 207-1, the helper device 300 overhears data transmitted between the source device 200 and the destination device 400. The overheard data is stored in a memory of the helper device 300. The memory is a memory device installed in the helper device 300, and may be, for example, a flash memory or a hard disk.

In step 209, the destination device 400 sends an ACK signal to the source device 200 if the data transmission from the source device 200 is completed. In step 209-1, the helper device 300 overhears the ACK signal transmitted from the destination device 400 to the source device 200. The ACK signal includes information indicating whether the transmission of each data block is successful. By decoding the ACK signal, the helper device 300 may determine a unique number of transmission-failed data blocks in the data transmitted by the source device 200.

In step 211, the helper device 300 overhears, at its data transmission order, ACK signals for the data blocks relating to other helper devices until the data transmission time for the helper device 300 arrives, as defined by the scheduling order, to determine a data block the helper device 300 will transmit in its data transmission slot. The helper device 300 generates transmission data for cooperative communication if there is a data block to transmit. In step 211, the helper device 300 generates transmission data by piggybacking the data block to be subject to cooperative communication (i.e., a transmission-failed data block from the source device 200) on the data which the helper device 300 will transmit to the destination device 400. The helper device 300 inserts a discriminator for discriminating between its data and the transmission-failed data block of the source device 200. In the helper device 300, the priority of block recombination is in the order of its data and the data block to be subject to cooperative communication, and the helper device 300 continuously performs cooperative communication until the resources allocated to the helper device 300 itself are exhausted. If the helper device 300 has multiple connections with the use of multiple CIDs, the helper device 300 performs cooperative communication by repeating the same operation for every link.

In step 213, the helper device 300 transmits the generated transmission data to the destination device 400.

In step 215, the destination device 400 sends an ACK signal for the transmission data received from the helper device 300, to the source device 200 and the helper device 300. The destination device 400 separately sends an ACK signal for the data of the helper device 300 and an ACK signal for cooperative communication data (i.e., a transmission-failed data block of the source device 200), thereby increasing the rationality of block recombination of other helper devices. If all blocks are normally received by cooperative communication, the helper device 300 no longer attempts cooperative communication.

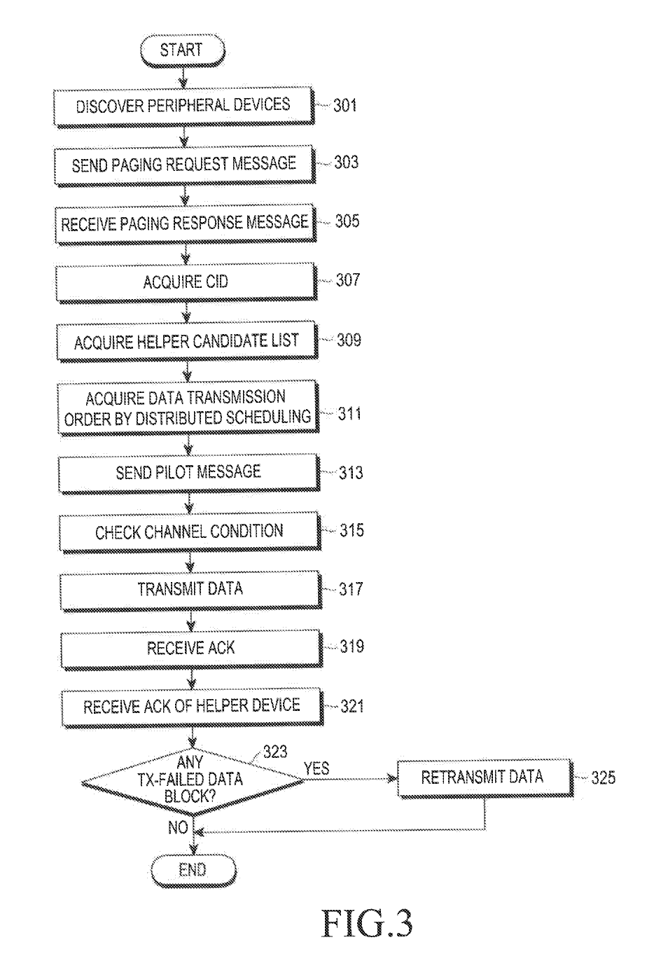

A data transmission process performed in each of the source device 200, the helper device 300, and the destination device 400 is described below with reference to FIGS. 3 to 5.

FIG. 3 shows a process of transmitting data in a source device according to an exemplary embodiment of the present invention.

Referring to FIG. 3, in step 301, the source device 200 discovers devices it can communicate with, through the discovery process 110. In step 303, the source device 200 sends a paging request message to the device it desires to communicate with (i.e., the destination device 400) using the resources allocated thereto, by performing the paging process 130. The source device 200 receives a paging response message corresponding to the paging request message from the destination device 400 in step 305, and acquires a CID by decoding the paging response message in step 307. In step 309, the source device 200 acquires a list of and CIDs of helper devices that are likely to help the source device 300. In step 311, the source device 200 determines the priority of data transmission with its CID by performing the scheduling process 150, and determines its communication order through interference control by negotiating with other devices. Through the scheduling process 150, the source device 200 may acquire the transmission order of the helper device 300 that is likely to help the source device 200. In steps 313 and 315, during data transmission, the source device 200 exchange pilot messages with the destination device 400 to determine the channel condition, and exchanges physical information. The source device 200 transmits data to the destination device 400 in step 317, and receives an ACK signal including information indicating the success/failure in transmission of each data block, from the destination device 400 in step 319.

In step 321, the source device 200 receives from the destination device 400 an ACK signal that is sent after data transmission of the helper device 300 is completed, according to the scheduling order. In step 323, based on the ACK signal of the helper device 300, the source device 200 finally determines whether there is data transmission-failed even by the helper device 300. If there is transmission-failed data, the source device 200 retransmits the transmission-failed data in step 325.

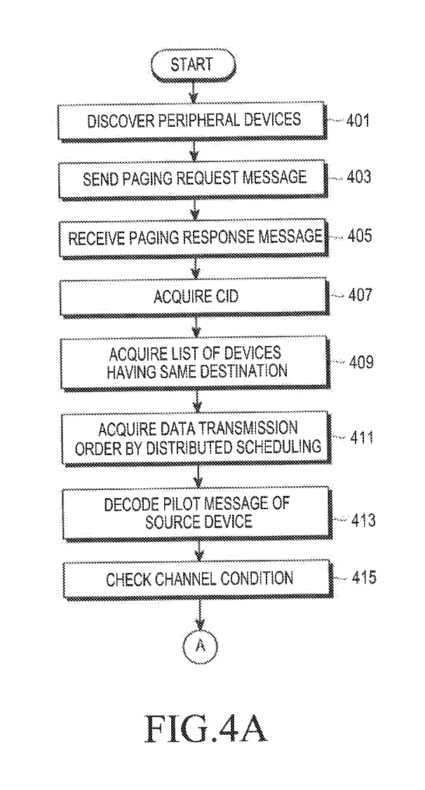

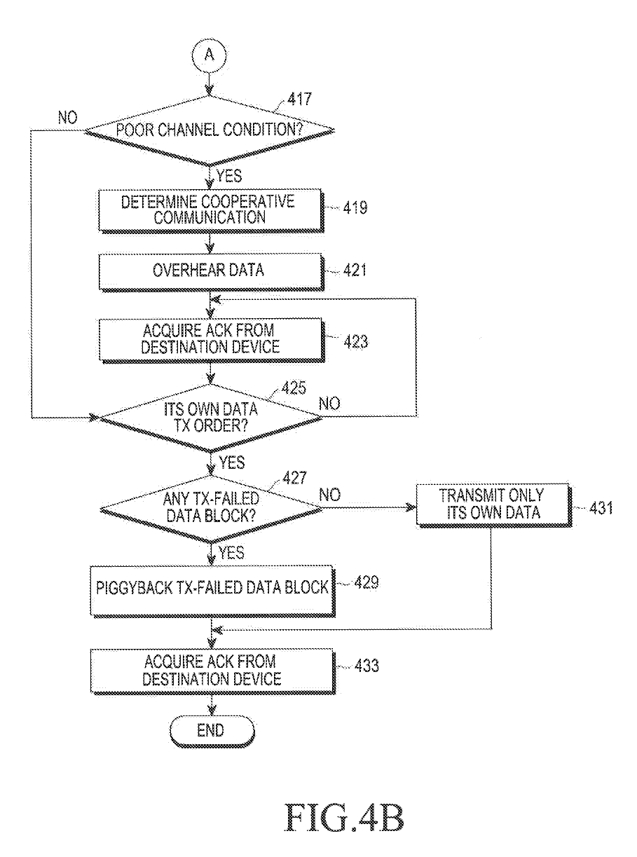

FIGS. 4A and 4B show a process of transmitting data in a helper device according to an exemplary embodiment of the present invention.

Referring to FIGS. 4A and 4B, in step 401, the helper device 300 discovers devices it can communicate with, through the discovery process 110. In step 403, the helper device 300 sends a paging request message to the device it desires to communicate with (i.e., the destination device 400) using the resources allocated thereto, by performing the paging process 130. The helper device 300 receives a paging response message corresponding to the paging request message from the destination device 400 in step 405, acquires a CID by decoding the paging response message in step 407, and determines a list of devices having the same destination in step 409. In step 409, the helper device 300 may obtain information about the source device 200 that the helper device 300 can help.

The helper device 300 determines a transmission time of the source device 200, which is scheduled to precede the helper device 300's transmission time in the scheduling process 150, in step 411, decodes a pilot message of the source device 200 in step 413, and determines the channel condition and physical information of the source device 200 in step 415. In step 417, the helper device 300 compares a channel condition between the source device 200 and the destination device 400 with a condition of a channel passing through the helper device 300 itself. If the channel condition between the source device 200 and the destination device 400 is worse than the condition of a channel passing through the helper device 300 itself, the helper device 300 proceeds to step 419. Otherwise, the helper device 300 proceeds to step 425. The helper device 300 determines cooperative communication with the source device 200 in step 419, and overhears data that is transmitted to the destination device 400 at the transmission time of the source device 200, and stores the overheard data in a memory in step 421. In step 423, the helper device 300 overhears an ACK signal that is sent from the destination device 400 to the source device 200, and decodes the ACK signal to identify whether any transmission-failed data blocks are present in the data of the source device 200. The helper device 300, together with the source device 200, double-checks the transmission-failed data block caused by the cooperative communication of other helper devices.

In step 425, the helper device 300 determines whether its own data transmission order or time has arrived. If its data transmission order has arrived, the helper device 300 proceeds to step 427. Otherwise, the helper device 300 proceeds to step 423. In step 427, the helper device 300 determines whether there is a transmission-failed data block in the data of the source device 200. If there is a transmission-failed data block, the helper device proceeds to step 429. Otherwise, the helper device 300 proceeds to step 431. In step 429, the helper device 300 piggybacks the transmission-failed data block on its transmission data. The transmission-failed data blocks are piggybacked in turn, and the piggyback continues until the allocated resources are exhausted. On the other hand, if the transmission of all data blocks by other helper devices or the source device 200 is successful, the helper device 300 transmits only its data to the destination device 400 after deleting the transmission-failed data block of the source device 200, which is stored in the memory, in step 431. In step 433, the helper device 300 receives an ACK signal from the destination device 400.

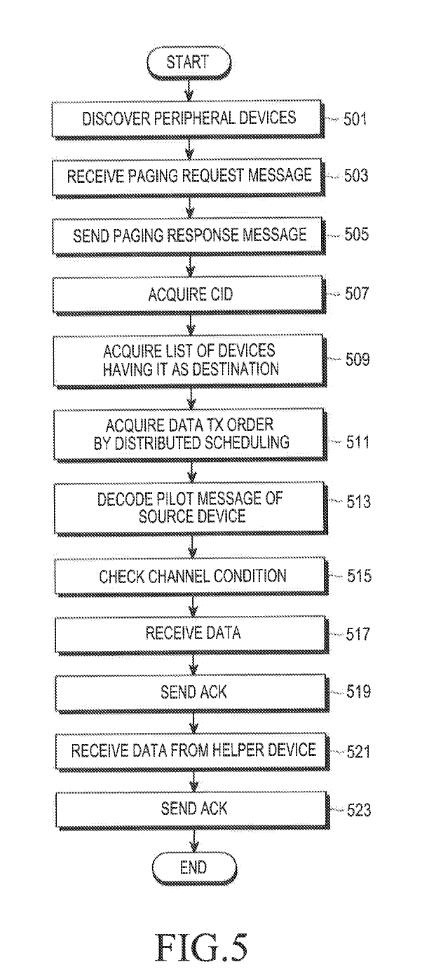

FIG. 5 shows a process of transmitting data in a destination device according to an exemplary embodiment of the present invention.

Referring to FIG. 5, in step 501, the destination device 400 discovers devices it can communicate with, through the discovery process 110. In step 503, the destination device 400 receives a paging request message from the devices desiring to transmit data thereto (i.e., the source device 200 and the helper device 300), by performing the paging process 130. In step 505, the destination device 400 sends a paging response message corresponding to the paging request message to the devices desiring to transmit data thereto. The destination device 400 acquires a CID for link scheduling to other devices in step 507, and determines a list of devices having the destination device 400 itself as a destination in step 509. The source device 200 and the helper device 300 acquire a scheduled CID, and the destination device 400 transmits the scheduled CID with a group ACK signal, allowing all of the peripheral devices to determine a device associated with a particular data transmission.

The destination device 400 acquires the data transmission order by distributed scheduling in step 511, decodes a pilot message received from the source device 200 in step 513, and determines the channel condition with the source device 200 and exchange physical information with the source device 200 in step 515. The destination device 400 receives data from the source device 200 based on the physical information in step 517, and sends to the source device 200 an ACK signal including information indicating the success/failure in transmission of each of the received data blocks, in step 519.

In step 521, the destination device 400 receives from the helper device 300 the data that is generated by piggybacking the transmission-failed data block of the source device 200 on the data of the helper device 300. In step 523, the destination device 400 sends an ACK signal configured as a response to the data of the helper device 300 and an ACK signal configured as a response to the transmission-failed data block of the source device 200, to the helper device 300 and the source device 200, respectively. The destination device 400 sends to the helper device 300 and the source device 200 an ACK signal that is configured as a transmission entity by grouping a response to the transmission-failed data block of the source device 200 and a response to the data of the helper device 300.

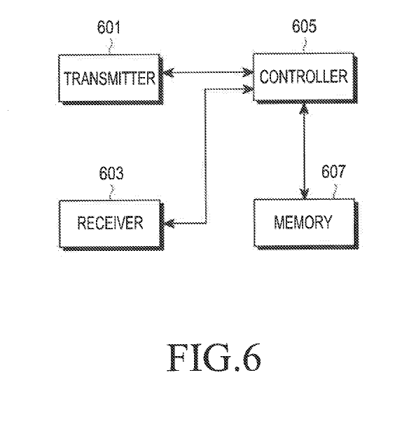

FIG. 6 shows an apparatus for transmitting data in a device according to an exemplary embodiment of the present invention.

Referring to FIG. 6, the apparatus may be any one of the source device 200, the helper device 300 and the destination device 400 depending on its role. A detailed operation of each device has been described with reference to FIGS. 3 to 5, so a detailed description thereof will be omitted. The device includes a transmitter 601, a receiver 603, a controller 605, and a memory 607.

In accordance with an exemplary embodiment of the present invention, the transmitter 601 sends at least one of a pilot message, a paging request message, a paging response message, data, and an ACK signal to another device. The receiver 603 receives at least one of a pilot message, a paging request message, a paging response message, data, and an ACK signal from another device.

The controller 605 controls an operation of sending and receiving messages according to an exemplary embodiment of the present invention. If the device of FIG. 6 operates as the helper device 300, the controller 605 compares a channel condition between the source device 200 and the destination device 400 with a channel condition between the helper device 300 and the destination device 400, and determines cooperative communication for the source device 200 if the channel condition between the source device 200 and the destination device 400 is worse than the channel condition between the helper device 300 and the destination device 400. The controller 605 overhears data transmitted from the source device 200 to the destination device 400 and overhears an ACK signal transmitted from the destination device 400 to the source device 200 via the receiver 603, to determine whether any transmission-failed data block of the source device 200 is present. If there are data transmission resources left at a predetermined scheduled data transmission time of the helper device 300, the controller 605 generates transmission data by piggybacking the transmission-failed data block of the source device 200 on the transmission data of the helper device 300. The controller 605 controls the transmitter 601 to transmit the generated data to the destination device 400, and controls the receiver 603 to receive an ACK signal including a response to the transmission data of the helper device 300 and a response to the transmission-failed data block of the source device 200, from the destination device 400.

The memory 607 stores transmission data of the helper device 300. If the device of FIG. 6 operates as the helper device 300, the memory 607 stores the transmission-failed data block of the source device 200. If another helper device has successfully transmitted the transmission-failed data block of the source device 200, the controller 605 deletes the transmission-failed data block of the source device 200, from the memory 607.

Although the transmitter 601 and the receiver 603 are assumed to be implemented as separate units in FIG. 6, it will be apparent to those of ordinary skill in the art that they may be implemented as a single unit. Similarly, the device may be any device capable of participating in D2D communication, such as a smartphone, tablet, laptop computer, desktop computer, or the like.

As is apparent from the foregoing description, the present invention may efficiently transmit data between devices in the D2D service. In addition, the present invention may efficiently use resources for data transmission in the D2D service. Besides, the present invention may ensure fast data transmission between devices in the D2D service. A variety of other effects may be seen literally or implicitly from the foregoing description of the present invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting data in a second device that performs a Device-to-Device (D2D) service, the method comprising:
determining cooperative communication, if a value indicating a channel condition between a first device and a third device is less than or equal to a predetermined threshold;
overhearing data transmitted from the first device to the third device and overhearing a response signal transmitted from the third device to the first device, to identify a transmission-failed data block of the first device; and
if there are data transmission resources left at a predetermined scheduled data transmission time, transmitting the transmission-failed data block of the first device to the third device by piggybacking the transmission-failed data block on transmission data of the second device.

2. The method of claim 1, wherein the predetermined threshold is a value indicating a channel condition between the second device and the third device.

3. The method of claim 1, further comprising receiving, from the third device, a response signal to the transmission data of the second device and a response signal to the transmission-failed data block of the first device.

4. The method of claim 1, further comprising inserting a discriminator for discriminating between the transmission data of the second device and the transmission-failed data block of the first device, when piggybacking the transmission-failed data block of the first device on the transmission data of the second device.

5. The method of claim 1, further comprising deleting the transmission-failed data block of the second device, which is stored in a memory, if the transmission of the transmission-failed data block of the first device is successful in a fourth device.

6. The method of claim 1, further comprising:
discovering the first device and the third device;
sending a paging request message to the third device;
receiving a paging response message corresponding to the paging request message from the third device;
generating a list including the third device and having, as a destination address, a Connection ID (CID) included in the paging response message; and
determining a channel condition between the first device and the third device by decoding a pilot message of the first device.

7. The method of claim 1, further comprising:
determining to exit cooperative communication if all data blocks are successfully received at the third device.

8. The method of claim 1, further comprising:
receiving ACKnowledgment (ACK) signals from the third device identifying data blocks successfully received at the third device; and
at the predetermined scheduled data transmission time, transmitting the transmission-failed data blocks according to the received ACK signals.

9. An apparatus for transmitting data in a second device that performs a Device-to-Device (D2D) service, the apparatus comprising:
a controller for, if a value indicating a channel condition between a first device and a third device is less than or equal to a predetermined threshold, determining cooperative communication, for overhearing data transmitted from the first device to the third device and overhearing a response signal transmitted from the third device to the first device via a receiver to identify a transmission-failed data block of the first device, and if there are data transmission resources left at a predetermined scheduled data transmission time, for generating data to transmit by piggybacking the transmission-failed data block of the first device on transmission data of the second device;
a transmitter for transmitting the generated data; and
a memory for storing the transmission-failed data block of the first device.

10. The apparatus of claim 9, wherein the predetermined threshold is a value indicating a channel condition between the second device and the third device.

11. The apparatus of claim 9, wherein the receiver receives, from the third device, a response signal to the transmission data of the second device and a response signal to the transmission-failed data block of the first device.

12. The apparatus of claim 9, wherein the controller inserts a discriminator for discriminating between the transmission data of the second device and the transmission-failed data block of the first device, when piggybacking the transmission-failed data block of the first device on the transmission data of the second device.

13. The apparatus of claim 9, wherein the controller deletes the transmission-failed data block of the second device from the memory, if the transmission of the transmission-failed data block of the first device is successful in a fourth device.

14. The apparatus of claim 9, wherein the controller discovers the first device and the third device, controls the transmitter to send a paging request message to the third device, controls the receiver to receive a paging response message corresponding to the paging request message from the third device, generates a list including the third device and having, as a destination address, a Connection ID (CID) included in the paging response message, and determines a channel condition between the first device and the third device by decoding a pilot message of the first device.

15. The apparatus of claim 9, wherein the controller determines to exit cooperative communication if all data blocks are successfully received at the third device.

16. The apparatus of claim 9, wherein the controller receives ACKnowledgment (ACK) signals from the third device identifying data blocks successfully received at the third device, and at the predetermined scheduled data transmission time, transmits the transmission-failed data blocks according to the received ACK signals.
